(19) United States
(12) Patent Application Publication
(10) Pub. No.: US 2024/0028282 A1
(43) Pub. Date: Jan. 25, 2024

(54) DEVICE CONNECTORS FOR SENSOR INTEGRATION

(71) Applicant: Apple Inc., Cupertino, CA (US)

(72) Inventors: Darshan R. Kasar, San Francisco, CA (US); Grant H. Mulliken, Los Gatos, CA (US); Javier Mendez, San Jose, CA (US); Erin M. Bosch, San Jose, CA (US)

(21) Appl. No.: 18/342,545

(22) Filed: Jun. 27, 2023

Related U.S. Application Data
(60) Provisional application No. 63/369,105, filed on Jul. 22, 2022.

(51) Int. Cl. G06F 3/14; G06F 3/01

(52) U.S. Cl. CPC G06F 3/14; G06F 3/011

(57) ABSTRACT

An apparatus includes a display, a facial interface, a sensor attached to the facial interface, and at least one of a communication interface or a power interface coupled to the sensor.

### CROSS-REFERENCE TO RELATED APPLICATION(S)

This claims priority to U.S. Provisional Patent Application No. 63/369,105, filed 22 Jul. 2022, and entitled “DEVICE CONNECTORS FOR SENSOR INTEGRATION,” the entire disclosure of which is hereby incorporated by reference.

### FIELD

The described embodiments relate generally to a connector in a head-mountable device. More particularly, the present embodiments relate to a connector in a head-mountable device that enables sensor and active component integration.

### BACKGROUND

Recent advances in portable computing have enabled head-mountable devices (HMD) that provide augmented and virtual reality (AR/VR) experiences to users. These head-mountable devices have many components, such as a display, viewing frame, lens, battery, and other components. Certain components of the head-mountable device can also help create a unique user experience. In particular, head-mountable devices typically provide a distraction-free setting by blocking or sealing out the outer environment (e.g., ambient light). In such a shielded setting, a user can better interact with visualizations presented on the display of the head-mountable device.

Head-mountable devices are also equipped with sensors. These sensors can be utilized for different purposes, such as detecting the user's environment. To make use of such sensors, power and sensor communication are needed.

Unfortunately, power and communication functionality in conventional head-mountable devices are implemented in rudimentary ways (if any) that limit a user experience or inefficiently leverage sensor data. For example, some head-mountable devices may only provide a limited number of sensors, which can be insufficient to provide an immersive user experience. Furthermore, adding additional sensors can require more power and data connections, which in conventional head-mountable devices lends to bulky and cumbersome devices.

### SUMMARY

In at least one example of the present disclosure, an apparatus includes a display, a facial interface, a sensor attached to the facial interface, and at least one communication interface or a power interface coupled to the sensor.

In one example, the apparatus further includes a sensor controller, the sensor controller including a processors and a memory device storing computer-executable instructions that, when executed by the processors, cause the sensor controller to receive sensor data from the sensor via the communication interface and transmit a signal based on the sensor data. In one example, at least one of the communication interface or the power interface is positioned between the display and the facial interface. In one example, the communication interface includes a wireless communication interface. In one example, the wireless communication interface is waterproof. In one example, the power interface includes an electromechanical interface with electrically conductive contacts. In one example, the power interface includes an inductive charging coil. In one example, the communication interface and the power interface include a shared interface.

In at least one example of the present disclosure, an apparatus includes a facial interface, a sensor attached to the facial interface, a power source, a processor, and an electromechanical connection positioned adjacent to a temple region of a head.

In one example, the electromechanical connection includes a communication interface between the processor and the sensor. In one example, the electromechanical connection includes a power interface between the power source and the sensor. In one example the electromechanical connection includes a communication interface and a power interface. In one example, the electromechanical connection includes one of a strap connection, a power connection, or a display connection. In one example, the sensor includes a biometric sensor that includes a temperature sensor, a respiration sensor, a stress response sensor, a heart activity sensor, or a brain activity sensor.

In at least on example of the present disclosure, an apparatus includes a facial interface, a sensor attached to the facial interface, and a wireless charging interface positioned adjacent to the facial interface and the sensor.

In one example, a display includes the facial interface including a first surface adjacent to the display, and a second surface opposing the first surface. The wireless charging interface can include an inductive coiled positioned at least partially around the first surface. In one example, the inductive coil wraps around the first surface adjacent to a first nasal portion, a first eye region, a forehead region, a second eye region, and a second nasal region when the apparatus is donned. In one example, the facial interface defines a raceway around a perimeter of the facial interface, the inductive coil being positioned inside the raceway. In one example, the apparatus includes a processor and an optical communication interface between the processor and the sensor. In one example the apparatus further includes a communication interface resistant to biological material ingress.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view profile of an example head-mountable device including a facial interface.

FIG. 2A shows a side view of an example head-mountable device including a facial interface.

FIG. 2B shows a front view of an example head-mountable device including a facial interface.

FIG. 3 shows an example process flow for transmitting a sensor signal via a communication interface in a head-mountable device.

FIG. 4 shows an example process flow for transmitting sensor feedback and updated display instructions via a communication interface of a head-mountable device.

FIG. 5 shows an example process flow for transmitting sensor power and display power via a power interface of a head-mountable device.

FIG. 6 shows an example communication/power interface of a head-mountable device.

FIG. 7 shows an example wireless charging interface of a head-mountable device.

### DETAILED DESCRIPTION

Reference will now be made in detail to representative embodiments illustrated in the accompanying drawings. It should be understood that the following descriptions are not intended to limit the embodiments to one preferred embodiment. Rather, it is intended to cover alternatives, modifications, and equivalents as can be included within the spirit and scope of the described embodiments as defined by the appended claims.

The following disclosure relates to power and communication interfaces (e.g., connectors) in a head-mountable device. More particularly, the present embodiments relate to connectors for enabling sensor and active component integration in head-mountable devices used for AR/VR experiences. These connectors can relay power to the sensors, as well as feedback data from the sensors to system components (e.g., head-mountable device processors).

In one example, the head-mountable device of the present disclosure includes connectors positioned on or within a light seal portion (hereafter “light seal”). Light seals enable a user to experience a light shielded environment, where outside ambient light is blocked from the user field of view. The shielded environment allows for better user interaction and a more immersive experience. The light seal, as a facial interface, can be customized to a user's facial profile such that the light seal physically interfaces with the user's face to fit snugly on or around the forehead, eyes, nose, and other facial features or bones that can vary user to user. Additionally, a light seal can include components connecting the display to the facial interface, such as a webbing, housing, or frame positioned between the display and the facial interface.

Conventional light seals of conventional head-mountable devices are passive. Indeed, passive light seals create a light shielded environment, but do not include active component integration. Therefore, conventional light seals do not provide power or communication interfaces for integrating sensors and active components.

By contrast, a light seal containing active components can provide electrical and data connections between the display and processor or other components. These connections, which can be physical or wireless, can also transmit power and provide sensor data creating a highly customized user experience.

Sensors are important to create a customized user experience. An active light seal can contain sensors to measure a user's response or engagement via indicators, such as core body temperature, sweat, heart rate, electrical signals from the heart (e.g., ECG, EKG, etc.), frontal lobe activity, etc. The sensor data can be used as feedback data, for example, to monitor user fatigue or determine activity-specific metrics.

In one example, a connector positioned within an active light seal allows the sensors to easily interface with other components without the need for additional ports or connections. To illustrate, the head-mountable device of the present disclosure uses a connection module or structure (e.g., for data) between the display and the HMD processor. In addition, the head-mountable device uses at least a portion of the same connection structure or module between the sensors and the HMD processor. Similarly, the head-mountable device of the present disclosure can provide power to both the display and the sensors through a same connection module or structure. In certain implementations, the connector is positioned within the head-mountable device at a location configured to be adjacent to a temple region of a head (e.g., a user head). At this location, the head-mountable device can leverage shared connections.

In some examples, the connector (or attachment interface) includes a mechanical connection. Utilizing certain mechanical connections can help mitigate environmental and biological ingress into the attachment interface. Mechanical connections can also be cost-effective.

In other examples, the connector (or attachment interface) includes a wireless connection. For instance, the head-mountable device can provide power to the sensors via an inductive coil around a perimeter of the light seal. In certain instances, the head-mountable device can transmit sensor data to/from the sensors via an optical connection (e.g., 60 GHz connection). Wireless connections can also help mitigate environmental and biological ingress, being more sealed and less exposed to the environment.

In at least one example, an apparatus includes a display, a facial interface with a sensor attached, and at least one of a communication or a power interface coupled to the sensor. The apparatus can further include a sensor controller, which can include a processor and a memory device. The memory device can store computer-executable instructions that, when executed by the processor, can cause the sensor controller to receive sensor data from the sensor via the communication interface and transmit a signal based on the sensor data. The communication interface or the power interface can be positioned between the display and the facial interface.

Accordingly, the apparatus and systems described herein, can provide an active a light seal for a head-mountable device. With an active light seal as disclosed herein, the head-mountable device can flexibly provide myriad different sensor configurations and enhanced sensor-based communication.

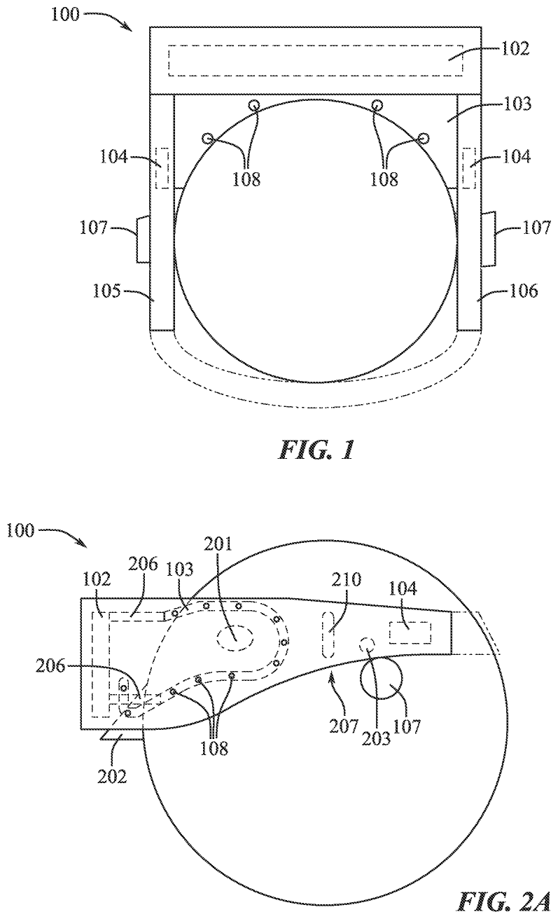

These and other embodiments are discussed below with reference to FIGS. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view profile of a head-mountable device 100 worn on a user head. The head-mountable device 100 can include a display 102 (e.g., one or more optical lenses or display screens in front of the eyes of the user). The display 102 can include a display for presenting an augmented reality visualization, a virtual reality visualization, or other suitable visualization.

The head-mountable device 100 also includes a facial interface 103 and sensors 108 attached to (or embedded within) the facial interface 103. As used herein, the term “facial interface” refers to a portion of the head-mountable device 100 that engages a user face. In particular, a facial interface includes portions of the head-mountable device 100 that conform to (e.g., compress against) regions of a user face. To illustrate, a facial interface can include a pliant (or semi-pliant) facetrack or lumen that spans the forehead, wraps around the eyes, contacts the zygoma and maxilla regions of the face, and bridges the nose. In addition, a facial interface can include various components forming a structure, webbing, or frame of a head-mountable device disposed between the display 102 and the user skin. In particular implementations, a facial interface can include a seal (e.g., a light seal, environment seal, dust seal, air seal, etc.). It will be appreciated that the term “seal” can include partial seals or inhibitors, in addition to complete seals (e.g., a partial light seal where some ambient light is blocked and a complete light seal where all ambient light is blocked when the head-mountable device is donned).

In addition, as used herein, the term “sensor” refers to one or more different sensing devices, such as a camera or imaging device, temperature device, oxygen device, movement device, brain activity device, sweat gland activity device, breathing activity device, muscle contraction device, etc. Some particular examples of sensors include an electrooculography sensor, electrocardiography sensor, EKG sensor, heart rate variability sensor, blood volume pulse sensor, SpO2 sensor, compact pressure sensor, electromyography sensor, core-body temperature sensor, galvanic skin sensor, accelerometer, gyroscope, magnetometer, inclinometer, barometer, infrared sensor, global positioning system sensor, etc.

The head-mountable device 100 further includes an HMD processor/memory 104. The HMD processor/memory 104 includes one or more processors (e.g., a system on chip, integrated circuit, driver, microcontroller, application processor, crossover processor, etc.). Further the HMD processor/memory 104 can include one or more memory devices (e.g., individual nonvolatile memory, processor-embedded nonvolatile memory, random access memory, memory integrated circuits, DRAM chips, stacked memory modules, storage devices, memory partitions, etc.). In certain implementations, the HMD processor/memory 104 is communicatively coupled to a power source (e.g., a battery).

In one or more examples, the HMD processor/memory 104 stores sensor data received from the sensors 108. Additionally or alternatively, the HMD processor/memory 104 receives and/or transmits signals based on sensor data. For example, as will be described below, the HMD processor/memory 104 can transmit a signal to the display 102 based on the sensor data (e.g., causing the display 102 to present a certain message, power off, etc.).

Additionally shown in FIG. 1, the head-mountable device 100 includes one or more arms 105, 106. The arms 105, 106 are connected to the display 102 and extend distally toward the rear of the head. The arms 105, 106 are configured to secure the display 102 in a position relative to the head (e.g., such that the display 102 is maintained in front of a user's eyes). For example, the arms 105, 106 extend over the user's ears 107. In certain examples, the arms 105, 106 rest on the user's ears 107 to secure the head-mountable device 100 via friction between the arms 105, 106 and the head. Additionally or alternatively, the arms 105, 106 can rest against the head. For example, the arms 105, 106 can apply opposing pressures to the sides of the head to secure the head-mountable device 100 to the head. Optionally, the arms 105, 106 can be connected to each other via a strap (shown in dashed lines) that can compress the head-mountable device 100 against the head).

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

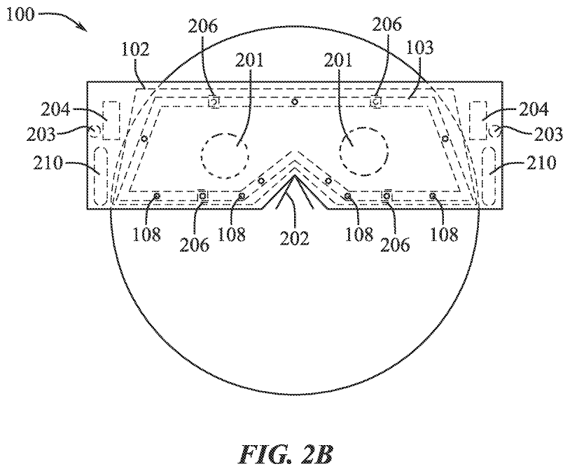

FIGS. 2A-2B respectively illustrate side and front view profiles of an example of the head-mountable device 100. As discussed above, the head-mountable device 100 includes the display 102, the facial interface 103, the HMD processor/memory 104, and the sensors 108. The facial interface 103 can indeed wrap around eyes 201 and bridge a nose 202 of a user. The head-mountable device 100 can also include connections 206 that movably constrain the display 102 relative to the facial interface 103. The connections 206 can be placed at myriad different locations along the display 102 and the facial interface 103 (e.g., at forehead and cheek regions of a user face). Examples of the connections 206 include a pivot connection, spring connection, etc.

Additionally shown in FIGS. 2A-2B, the head-mountable device 100 can include a power source 203. In some examples, the power source 203 can include one or more electrochemical cells with connections for powering electrical devices. For example, in some examples, the power source 203 includes a lithium ion battery, alkaline battery, carbon zinc battery, zinc air battery, lead-acid battery, nickel-cadmium battery, nickel-metal hydride battery, etc. It will therefore be appreciated that the power source 203 can be dispensable or rechargeable, as may be desired. In certain implementations, the power source 203 is connected to the HMD processor/memory 104 via one or more electrical connections. In some examples (albeit not required), the power source 203 is mounted to the HMD processor/memory 104.

The head-mountable device 100 can also include an interface 210. The interface 210 can be disposed between the sensors 108 and the power source 203. Similarly, the interface 210 can be positioned between the sensors 108 and the HMD processor/memory 104. For example, the interface 210 can be positioned at a temple region 207 (e.g., adjacent to a temple of a user head). As used herein, the term “temple region” refers to the anatomical region of a human head between an eye and an ear. In certain implementations, the interface 210 can be centrally located (e.g., at the temple region 207) to leverage shared connections with multiple components of the head-mountable device 100. As will be described below, the interface 210 can include a communication interface for relaying data and/or computer-executable instructions (e.g., based on sensor data from the sensors 108). Additionally or alternatively, the interface 210 can include a power interface for relaying power from the power source 203 to at least one of the display 102 or the sensors 108. Examples of such interfaces are also described in more detail below.

Any of the features, components, and/or parts, including the arrangements and configurations thereof shown in FIG. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2A-2B.

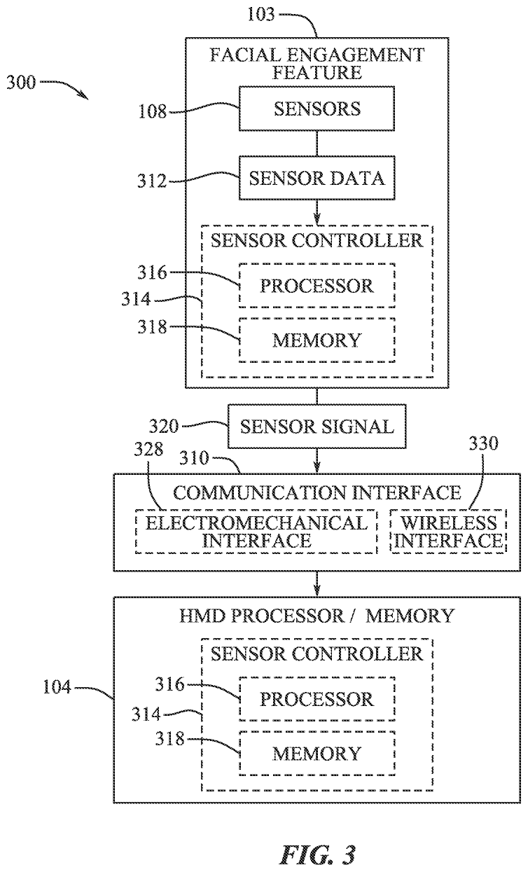

As mentioned above, the head-mountable device of the present disclosure can include one or more interfaces, including a communication interface for relaying signals between components (e.g., sensors, processors, etc.). In accordance with one or more such examples, FIG. 3 illustrates a process 300 for providing communication between the sensors 108 of the facial interface 306 and the HMD processor/memory 104.

In particular, FIG. 3 shows the sensors 108 generating sensor data 312. In some examples, sensor data 312 includes observed, measured, or estimated values determined by the sensors 108. For example, the sensor data 312 can include tables, graphs, vectors, data strings, etc. that include data values generated by the sensors 108.

In some examples, the facial interface 103 includes a sensor controller 314 (albeit not required, as indicated by the dashed lines for the sensor controller 314). Indeed, the sensor controller 314 can alternatively be integrated with the HMD processor/memory 104. However, as part of the facial interface 103, the sensor controller 314 can be integrated into the sensors 108 (e.g., physically part of or mounted to the sensors 108). Additionally or alternatively, the sensor controller 314 can be communicatively coupled to the sensors 108, but separately positioned on or within the facial interface 103. In particular examples, the sensor controller 314 includes a processor 316 and memory 318.

In some implementations, the processor 316 can include a system on chip, integrated circuit, driver, microcontroller, application processor, crossover processor, etc.). These or other components of the processor 316 can process and analyze the sensor data 312. For example, the processor 316 can utilize one or more algorithms to determine certain user states (e.g., elevated temperature, elevated stress response, irregular heartbeat, normal blood-oxygen level, etc.) based on the sensor data 312. To illustrate, the processor 316 can utilize one or more thresholds or acceptable ranges for the sensor data 312 to determine a corresponding user state. Additionally or alternatively, the processor 316 can utilize statistical anomalies to determine a corresponding abnormal (or normal) user state based on the sensor data 312 being outside of (or within), for instance, one standard deviation of sensor data.

The memory 318 can include one or more memory devices (e.g., individual nonvolatile memory, processor-embedded nonvolatile memory, random access memory, memory integrated circuits, DRAM chips, stacked memory modules, storage devices, memory partitions, etc.). In particular, the memory 318 can store the sensor data 312. In some implementations, the memory 318 can store the sensor data 312 for extended periods of time (e.g., until deleted). In other implementations, the memory 318 can store the sensor data 312 for shorter periods of time (e.g., minutes, hours, days, etc.).

In one or more examples, the processor 316 and the memory 318 are communicatively coupled. For example, the processor 316 can retrieve the sensor data 312 from the memory 318 to perform one or more analyses. To illustrate, the processor 316 can compare current sensor data with past sensor data for a similar or previous user activity from the memory 318. Based on the comparison, the processor 316 can identify abnormalities or determine other information (e.g., indications of heart rate trends, improvement, etc.).

Based on the sensor data 312, the sensor controller 314 generates a sensor signal 320. In one or more examples, the sensor signal 320 includes information representative of the sensor data 312. For example, the sensor signal 320 includes data indicative of a user state, statistics of the sensor data 312, etc. In certain implementations, the sensor signal 320 includes binary values (e.g., zeros and ones for certain detected user states). Additionally or alternatively, the sensor signal 320 includes consolidated, raw data from the sensor data 312 (e.g., abnormal portions of the sensor data 312).

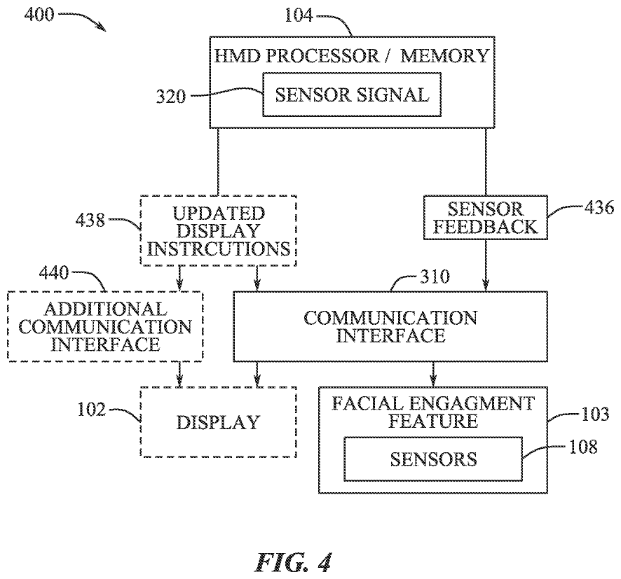

In other examples, the sensor signal 320 includes computer-executable instructions for use by other components of the head-mountable device 100. For example, the sensor controller 314 generates the sensor signal 320 with computer-executable instructions that, when executed by the HMD processor/memory 104, cause the display 102 to change a display output (e.g., as will be described below in relation to FIG. 4).

Still, in other examples, the sensor signal 320 includes all of the raw data from the sensor data 312. In this case, the sensor controller 314 may not be positioned within the facial interface 103. Rather, the sensor controller 314 can be integrated with the HMD processor/memory 104 (as optionally shown in FIG. 3). Thus, the sensor signal 320 can include the sensor data 312 as generated by the sensors 108, with no computer-executable instructions or additional (or alternative) representative information.

Further shown in FIG. 3, the process 300 includes relaying the sensor signal 320 to the HMD processor/memory 104 via a communication interface 310. The communication interface 310 can include an electromechanical communication interface 328 or a wireless communication interface 330. The electromechanical communication interface 328 can have an electromechanical connection between the sensors 108 and the HMD processor/memory 104. For instance, the electromechanical interface 328 connects data cables, wires, fibers, etc. between the sensors 108 and the HMD processor/memory 104. Examples of the electromechanical connection of the electromechanical interface 328 include mated pins, prongs, plugs, socket connectors, or other suitable mechanical contacts that are electrically conductive. In addition, examples of the electromechanical interface 328 include switches, relays, diodes, transistors, resistors, capacitors, transformers, amplifiers, fuses, inductors, potentiometers, etc.

In certain implementations, the electromechanical interface 328 includes electromechanical connections such as connections to a display or main component, connections to a strap or electronics in a strap, or connections to a power supply.

By contrast, the wireless interface 330 can include components for wireless data transmission between the sensors 108 and the HMD processor/memory 104. In some examples, the wireless interface 330 can connect the sensors 108 and the HMD processor/memory 104 via certain wireless communication protocols, such as via a wireless local area network protocol, wireless area network protocol, wireless personal area network protocol, wide area network protocol, etc. Some particular examples of wireless communication via such protocols include a Wi-Fi based communication, mesh network communication, BlueTooth® communication, near-field communication, low-energy communication, Zigbee communication, Z-wave communication, and 6LoWPAN communication. In a particular implementation, the wireless interface 330 connects the sensors 108 and the HMD processor/memory 104 via a wireless 60 GHz frequency.

In at least some instances, the wireless interface 330 can help mitigate biological material ingress because the wireless interface 330 is sealed (e.g., waterproof sealed, hermetically sealed, etc.). For example, the wireless interface 330 includes one or more gaskets, compression seals, sealants, etc. that help prevent (or reduce) biological material ingress into the wireless interface 330. In certain implementations, the wireless interface 330 is therefore resistant to lotions, oils, makeup, sweat, dirt, grime, etc. as exposed by contact with the human face, hands, and fingers.

Once the HMD processor/memory 104 receives the sensor signal 320, the HMD processor/memory 104 can generate one or more responsive signals (as will be described below in relation to FIG. 4). To do so, the HMD processor/memory 104 can utilize the sensor controller 314 to analyze raw sensor data in the sensor signal 320 in a same or similar manner as described above (except sensor signal 320 the HMD processor/memory 104, not the facial interface 103, includes the sensor controller 314).

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

As mentioned above, the HMD processor/memory 104 can generate responsive signals based on the sensor signal 320. In accordance with one or more examples of the present disclosure, FIG. 4 illustrates a process 400. As shown, the process 400 includes providing sensor feedback 436 to the sensors 108 via the communication interface 310 described above. In some examples, the sensor feedback 436 includes computer-executable instructions for the sensors 108 to modify, discontinue, or continue an aspect of determining the sensor data 312. For instance, the sensor feedback 436 includes a signal for one or more of the sensors 108 to change a sampling rate, modify a sensing location or user-skin datum, power on/off, reset, implement a different configuration of sensors, etc.

In one or more alternative examples, the HMD processor/memory 104 can generate the sensor feedback 436 in response to signals other than the sensor signal 320. For example, the HMD processor/memory 104 can generate the sensor feedback 436 in response to the HMD processor/memory 104 identifying a new user (or user profile), a different user activity, etc. As another example, the HMD processor/memory 104 can generate the sensor feedback 436 based on environmental conditions (e.g., loud ambient noise).

Additionally shown in FIG. 4, the HMD processor/memory 104 can generate updated display instructions 438 based on the sensor signal 320. The updated display instructions 438 can include one or more signals for the display 102 to change a display output. For example, the updated display instructions 438 can include computer-executable instructions for the display 102 to render a notification for presenting to the user (e.g., a recommendation to adjust the head-mountable device 100, charge the head-mountable device 100, move to a certain environmental location, etc.).

In some examples, the HMD processor/memory 104 transmits the updated display instructions 438 to the display 102 via the communication interface 310. In this case, the communication interface 310 is a shared interface. That is, the HMD processor/memory 104 uses the communication interface 310 to provide the updated display instructions 438 and the sensor feedback 436 to respective components. In at least some implementations, a shared interface can lend to decreased weight of the head-mountable device 100 and/or improved utilization of internal space within the head-mountable device 100.

In other examples, the HMD processor/memory 104 transmits the updated display instructions 438 to the display 102 via an additional communication interface 440 (separate from the communication interface 310). The additional communication interface 440 can be similar to the communication interface 310, albeit designated for the display 102.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

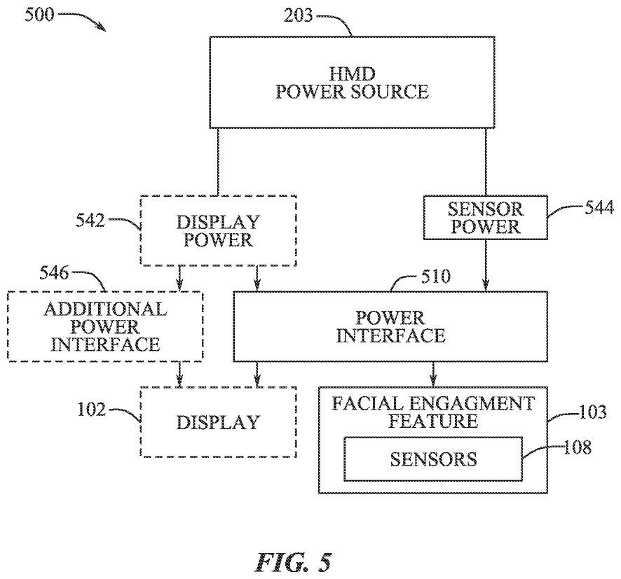

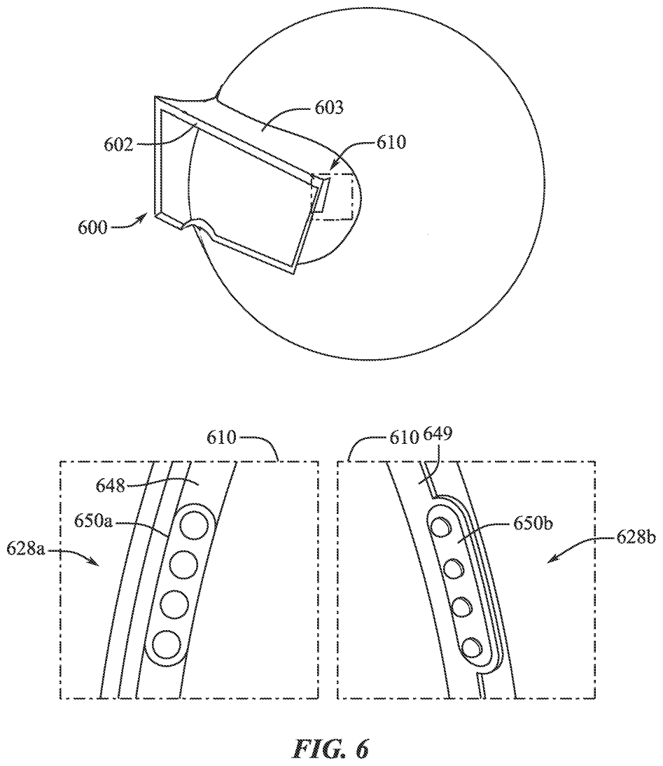

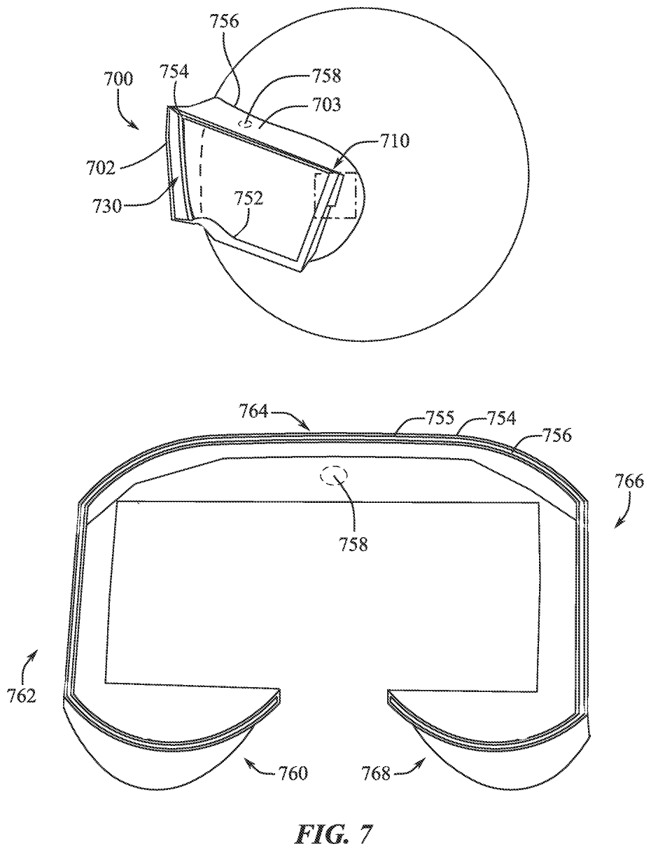

In some examples, the head-mountable device 100 of the present disclosure can implement a power interface between the sensors 108 and the power source 203. In accordance with one or more such examples, FIG. 5 illustrates a process 500 of a head-mountable device implementing a power interface 510 to relay power. In one or more examples, the power interface 510 includes the same or similar electrical connections as the communication interface 310 described above. In particular, the power interface 510 can include an electromechanical connection, such as a connection to a display or main electronic unit, to electronics in a strap, band, or arm, or a connection to a power source. The power interface 510 can also include a pogo-pin connection described below in relation to FIG. 6. Alternatively, the power interface 510 can include a wireless connection—similar to the wireless interface 330 of the communication interface 310. In certain implementations, the wireless connection between the power source 203 and the sensors 108 includes an inductive coil for wireless charging the sensors 108 (as will be described below in relation to FIG. 7).

As shown, the power source 203 transmits sensor power 544 to the power interface 510. In some examples, the sensor power 544 includes an electrical current or voltage for powering the sensors 108. In certain implementations, the sensor power 544 includes direct current. In other implementations the sensor power 544 includes alternating current.

Likewise, the power source 203 can optionally transmit display power 542 via the power interface 510. In this case, the power interface 510 can be a shared interface. That is, the power source 203 can relay power to both the sensors 108 and the display 102 via a shared interface (i.e., the power interface 510). In other instances, the power source 203 can transmit the display power 542 to the display 102 via an additional power interface 546 (separate from the power interface 510). The additional power interface 546 is similar to the power interface 510, except designated for the display 102.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

As mentioned above, the head-mountable device 100 can include certain types of electromechanical connections, such as a pogo-pin connection. In accordance with one or more such examples, FIG. 6 illustrates an example electromechanical connection of an example head-mountable device 600. As shown, the head-mountable device 600 includes an interface 610 configured to provide data and/or power to a display 602 and a facial interface 603 (particularly the sensors 108 not shown on or within the facial interface 603).

In particular, the interface 610 includes mating portions 628a-628b. The mating portion 628a includes a first surface 648 with receptacles 650a. In addition, the mating portion 628b includes a second surface 649 with pins 650b. The pins 650b are sized and shaped to electrically contact (e.g., fit at least partially inside) the receptacles 650a when the first surface 648 abuts the second surface 649. When the mating portions 628a-628b are connected in this manner, electrical signals can be relayed through the interface 610. That is, when connected in this manner, the interface 610 can provide data and/or power to the display 602 and the sensors 108 (not shown).

To illustrate, one or more of the pins 650b can include power-related pins (e.g., one pin for active power and one pin for ground). In addition, one or more pins of the 650b can include data pins. The number of pins can be modified within the scope of the present disclosure. As another example modification, each of the pins 650b can exclusively provide power or data, as may be desired.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

As also mentioned above, the head-mountable device of the present disclosure can include wireless interfaces. In accordance with one or more such examples, FIG. 7 illustrates an example of a wireless interface 710 of a head mountable device 700 and a wireless charging interface 730.

The wireless interface 710 can be the same as or similar to the wireless interface 330 described above. For example, the wireless interface 710 can include one or more optical components for wireless transmitting data. In certain implementations, the wireless interface 710 can also provide an electrical current to the wireless charging interface 730.

In certain examples, the wireless charging interface 730 can include one or more components for wirelessly providing power to the sensors 108 (e.g., a sensor 758) positioned on or within a facial interface 703. In some examples, the wireless charging interface 730 includes an inductive coil (e.g., for electromagnetic induction, electrodynamic induction, or electrostatic induction). In alternative examples, the wireless charging interface 730 includes components for radiated power transmission (e.g., microwave power, laser power, or radio wave power). Still, in other alternative examples, the wireless charging interface 730 includes components for resonance power transfer (e.g., electromagnetic resonance, evanescent wave coupling, or capacitive resonance coupling).

As shown in FIG. 7, the wireless charging interface 730 includes an inductive coil 756. In particular, the inductive coil 756 is positioned adjacent to the facial interface 706 and the sensor 758. For instance, the inductive coil 756 is positioned within a threshold distance of the sensor 758 for optimal power transfer to the sensor 758.

In a particular example, the inductive coil 756 is positioned at least partially around a first surface 754 positioned adjacent to the display 702. Indeed, the inductive coil 756 can wrap around the first surface 754 adjacent to a first nasal portion 760, a first eye region 762, a forehead region 764, a second eye region 766, and a second nasal region 768 when the head-mountable device 700 is donned. In certain implementations, the facial interface 703 can define a raceway or a perimeter lumen 755 or tube around the perimeter of the facial interface 703. Thus, in some instances, the inductive coil 756 can be positioned inside the perimeter lumen 755.

Although not shown, it will be appreciated that the wireless interface 710 and the wireless charging interface 730 can be coupled to a power source (e.g., the power source 203) and/or a processor (e.g., the HMD processor/memory 104) as similarly described above.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

To the extent possible and desired, personal information data can be collected and used to improve the functionality and personalization of the presently disclosed systems and methods. If used, retention, use, and dissemination should be performed with privacy policies and practices that are generally recognized as meeting or exceeding industry or governmental requirements for maintaining personal information data private and secure. Furthermore, any personal information data should be managed and handled in a way to minimize risks of unintentional or unauthorized access or use.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head mountable display (HMD), comprising:
a display;
a facial interface;
a sensor attached to the facial interface;
a communication interface connected to the sensor; and
a power interface connected to the sensor.

2. The HMD of claim 1, further comprising a sensor controller, the sensor controller comprising:
a processor; and
a memory device storing computer-executable instructions that, when executed by the processor, cause the sensor controller to:
receive sensor data from the sensor via the communication interface; and
transmit a signal based on the sensor data.

3. The HMD of claim 1, wherein at least one of the communication interface or the power interface is positioned between the display and the facial interface.

4. The HMD of claim 1, wherein the communication interface comprises a wireless communication interface.

5. The HMD of claim 4, wherein the wireless communication interface is sealed.

6. The HMD of claim 1, wherein the power interface comprises an electromechanical interface with electrically conductive contacts.

7. The HMD of claim 1, wherein the power interface comprises an inductive charging coil.

8. The HMD of claim 1, wherein the communication interface and the power interface comprise a shared interface.

9. An apparatus comprising:
a facial interface;
a sensor attached to the facial interface;
a power source;
a processor; and
an electromechanical connection between the sensor and each of the power source and the processor, the electromechanical connection positioned adjacent to a temple region of a head.

10. The apparatus of claim 9, wherein the electromechanical connection comprises a communication interface between the processor and the sensor.

11. The apparatus of claim 9, wherein the electromechanical connection comprises a power interface between the power source and the sensor.

12. The apparatus of claim 9, wherein the electromechanical connection comprises a communication interface and a power interface.

13. The apparatus of claim 9, wherein the electromechanical connection comprises a pogo-pin connection.

14. The apparatus of claim 9, wherein the sensor comprises a biometric sensor.

15. An apparatus comprising:
a facial interface;
a sensor attached to the facial interface; and
a wireless charging interface positioned adjacent to the facial interface and the sensor.

16. The apparatus of claim 15, further comprising a display, wherein:
the facial interface comprises a first surface adjacent to the display, and a second surface opposing the first surface; and
the wireless charging interface comprises an inductive coil positioned at least partially around the first surface.

17. The apparatus of claim 16, wherein the inductive coil wraps around the first surface adjacent to a first nasal portion, a first eye region, a forehead region, a second eye region, and a second nasal region when the apparatus is donned.

18. The apparatus of claim 16, wherein the facial interface defines a lumen around a perimeter of the facial interface, the inductive coil being positioned inside the lumen.

19. The apparatus of claim 15, further comprising:
a processor; and
an optical communication interface between the processor and the sensor.

20. The apparatus of claim 14, further comprising a communication interface resistant to biological material ingress.
